(19) United States
(12) Patent Application Publication
(10) Pub. No.: US 2009/0225155 A1
(43) Pub. Date: Sep. 10, 2009

(54) CELESTIAL BODY OBSERVATION DEVICE

(75) Inventor: Takayuki Hirotani, Akiruno-shi (JP)

Correspondence Address: TUROCY & WATSON, LLP, 127 Public Square, 57th Floor, Key Tower, CLEVELAND, OH, 44114, US

(73) Assignee: CASIO COMPUTER CO., LTD, Tokyo (JP)

(21) Appl. No.: 12/369,265

(22) Filed: Feb. 11, 2009

(30) Foreign Application Priority Data
Mar. 5, 2008 (JP) 2008-54691

(51) Int. Cl. H04N 7/18; G01S 1/00

(52) U.S. Cl. 348/61; 342/357.13; 348/E07.085

(57) ABSTRACT

A celestial body observation device having a camera unit 21, a star-related database 33 including a star map data file 35 that stores star map data having positions of stars and display information including names of the stars, a comparison and determination unit 31 that compares a pixel group contained in image data picked up by the camera unit 21 with star map data within a star map data file 24 and specifies a celestial body corresponding to the pixel group, and a display control unit 34 that acquires display information of star map data associated with the pixel group from the star map data file 35 on the basis of association between the pixel group specified by the comparison and determination unit 31 and the star and generates complex image data in which the display information is superimposed on the image data.

### CROSS-REFERENCE TO RELATED APPLICATIONS

This application is based upon and claims the benefit of priority from the prior Japanese Patent Application No. 2008-54691, filed Mar. 5, 2008, the entire contents of which are incorporated herein by reference.

### BACKGROUND OF THE INVENTION

1. Field of the Invention

The present invention relates to a celestial body observation device that provides various types of information to an observer during observations of a celestial body.

2. Description of the Related Art

Measuring the present position or accurate time by employing a GPS (Global Positioning System) is employed in many fields, for example, in car navigation. Because the present position can be measured, that is, positioned, with a GPS, a device has been suggested for displaying a star map that has to be visible from this position.

JP-A-2002-328624 suggests providing display means at an inner surface of a ceiling in an automobile cabin and displaying a star map including celestial bodies with a brightness equal to or higher than a predetermined brightness correspondingly to the present position of the vehicle and present time.

Further, JP-A-2003-316791 suggests a technology according to which a GPS device is installed on a cellular phone, a server sends celestial body information in the present position of the cellular phone to the cellular phone on the basis of the present position of the cellular phone, and the cellular phone displays the received information.

JP-A-2004-13066 discloses a feature of installing a geomagnetic sensor on a cellular phone and detecting the orientation of the cellular phone, thereby specifying a constellation that has to be positioned in this direction, and displaying the name of the constellation and the like on a display unit of the cellular device.

Within the framework of technology disclosed in all the aforementioned patent documents, information on celestial stars or constellations that will be possible to view in a present position is provided to an observer. Therefore, the observer has to perform an operation of comparing with the information displayed on a display screen of the cellular phone, while visually observing a celestial body. The resultant problem is that the comparison is sometimes difficult due to the state of the celestial body or a view line has to be moved between the sky and the screen to make the comparison and, therefore, specifying a celestial body positioned in the sky is not easy for the observer.

### SUMMARY OF THE INVENTION

It is an object of the present invention to provide a celestial body observation device that allows an observer to verify easily information on a celestial body positioned in the sky.

The object of the present invention is attained by a celestial body observation device comprising:

a camera;

a database comprising a celestial body data file that stores celestial body data having a position of a celestial body and display information including a name of the celestial body;

celestial body comparison and determination means for comparing a pixel group having a constant luminance contained in image data picked up by the camera with celestial body data within the celestial body data file and specifying a celestial body corresponding to the pixel group;

image data generation means for acquiring display information of celestial body data relating to the celestial body associated with the pixel group from the celestial body data file on the basis of association between the pixel group specified by the celestial body comparison and determination means and the celestial body and generating complex image data in which the display information is superimposed on the image data; and

display means for displaying the complex image data.

### BRIEF DESCRIPTION OF THE DRAWINGS

FIG. 1 is a block diagram illustrating a configuration of a celestial body observation device of the first embodiment of the present invention;

FIG. 2 is a block diagram illustrating functions of the celestial body observation device of the first embodiment;

FIG. 3 is a flowchart illustrating an example of processing executed in the celestial body observation device of the present embodiment;

FIG. 4 is a flowchart illustrating an example of comparison processing with star map data relating to the present embodiment;

FIG. 5 illustrates an example of a preview image and star map data corresponding to a specified sky;

FIG. 6 illustrates an example of a preview image and an image in which a constellation name and constellation lines are superimposed on the preview image;

FIG. 7 illustrates another example of a preview image and an image in which a star name and constellation lines are superimposed on the preview image;

FIG. 8 is a block diagram illustrating functions of the celestial body observation device of the second embodiment;

FIG. 9 is a flowchart illustrating an example of comparison processing with star map data and planet data in the second embodiment;

FIG. 10 illustrates an example of a preview image and an image in which a planet name is superimposed on the preview image; and

FIG. 11 illustrates another example of a preview image and an image in which a planet name and a horoscope display are superimposed on the preview image.

### DETAILED DESCRIPTION OF THE PREFERRED EMBODIMENTS

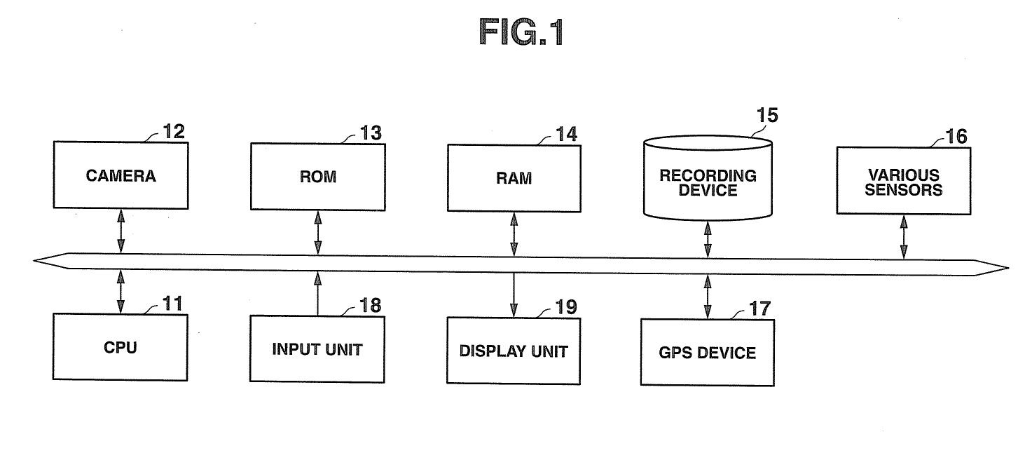

An embodiment of the present invention will be described below with reference to the appended drawings. FIG. 1 is a block diagram illustrating a configuration of a celestial body observation device of the first embodiment of the present invention. The celestial body observation device of the present embodiment is in the form of, for example, a digital camera. As shown in FIG. 1, the celestial body observation device has a CPU 11, a camera 12, a ROM 13, a RAM 14, a recording device 15, various sensors 16, a GPS device 17, an input unit 18, and a display unit 19. In the present description celestial bodies include fixed stars and planets, and the fixed stars will be simply referred to as “stars”.

The CPU 11 controls pick-up with the camera 12, zooming, etc. according to a program and also executes processing of various types such as acquisition of information relating to celestial bodies including fixed stars (stars) and planets in the sky according to the information from the sensors 16 or GPS 17. The ROM 13 stores programs for realizing various functions of the celestial body observation device, for example, a camera control program, a program for actuating the GPS device and positioning, and a program for comparing image data picked up with the camera 12 and the below-described star map data. The RAM 14 stores a program that has been read from the ROM 13 and developed and data acquired in the processing process such as image data picked up by the camera 12.

The recording device 15 is realized, for example, by a memory card or an USB memory and stores data of a below-described star-related DB 31 such as a star map data file 35 or image data picked up by the camera 12. It goes without saying that the recording device 15 may be realized by a hard disk device.

The sensors 16 include an azimuth sensor and an angle sensor and can detect an orientation or an angle of the celestial body observation device (in particular, orientation and angle of elevation of a lens of the camera 12). The GPS 17 receives electromagnetic waves (GPS electromagnetic wave) from GPS satellites and determines the present position and also acquires accurate present time on the basis of trajectory information of a predetermined number of GPS satellites and time. The input unit 18 has an input key or a switch and allows an observer to input the desired information. The display unit 19 is provided, for example, with a liquid crystal display device and can display an image picked up by the camera 12 and the like.

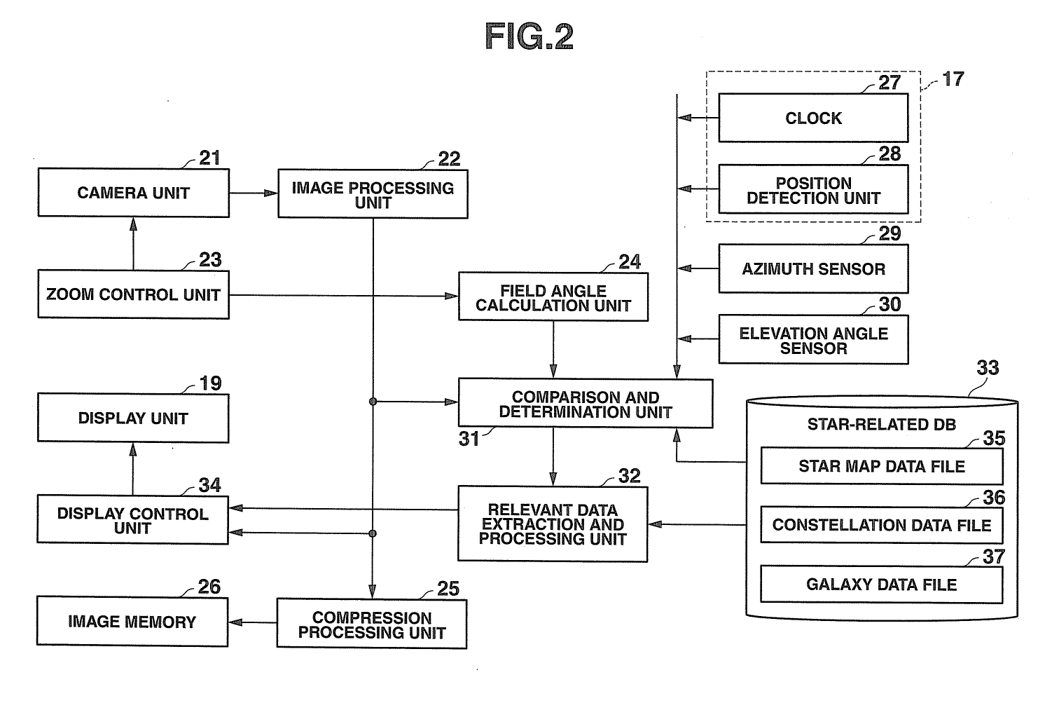

FIG. 2 is a block diagram illustrating functions of the celestial body observation device of the first embodiment. As shown in FIG. 2, from the functional standpoint, the celestial body observation device of the present embodiment includes a camera unit 21, an image processing unit 22, a zoom control unit 23, a field angle calculation unit 24, a compression processing unit 25, an image memory 26, a clock 27, a position detection unit 28, an azimuth sensor 28, and an elevation angle sensor 30, a comparison and determination unit 31, a relevant data extraction and processing unit 32, the star-related database (DB) 33, a display control unit 34, and a display unit 19. The camera unit 21 and zoom control unit 23 are realized by the camera 12. The image processing unit 22, field angle calculation unit 24, compression processing unit 25, comparison and determination unit 31, relevant data extraction and processing unit 32, and display control unit 34 are realized by the CPU 11. The image memory 26 or star-related DB 33 is realized by the RAM 14 or recording device 15.

The star-related DB 33 includes a star map data file 35 that includes information on a celestial body associated with position in the sky and time, a constellation data file 36 including information on celestial bodies constituting a constellation, and a galaxy data file 37 indicating a position of a galaxy in the sky. A star position that can be viewed on the sky differs depending on the observer's position (pick-up position) and time. Therefore, star map data of the star map data file 35 correspond to the present time (date and hour) and observer's position.

The image processing unit 22 implements processing necessary for image data provided by the camera unit 21 (for example, correction processing of color or the like and the below-described filtering processing). The zoom control unit 23 controls the lens of camera 21 correspondingly to the operation of a zoom switch contained in the input unit 18 by the observer. The field angle calculation unit 24 calculates a field angle of the lens of camera 21 controlled by the zoom control unit 23. A range of the sky that has been picked up by the camera 21 is defined, as will be described hereinbelow, by calculations of the field angle. The compression processing unit 25 compresses the image data outputted from the image processing unit 22 according to a predetermined format and stores the compressed data in the image memory 26.

The comparison and determination unit 31 specifies a celestial body included in the picked-up image on the basis of time information and position information from the GPS device 17, information from the azimuth sensor 29 and elevation angle sensor 30, field angle information from the field angle calculation unit 24, and the star map data file 35 in the star-related DB 33. The relevant data extraction and processing unit 32 reads necessary information relating to the specified celestial body from the star-related DB 33 correspondingly to the key operation of the input unit 18 by the user.

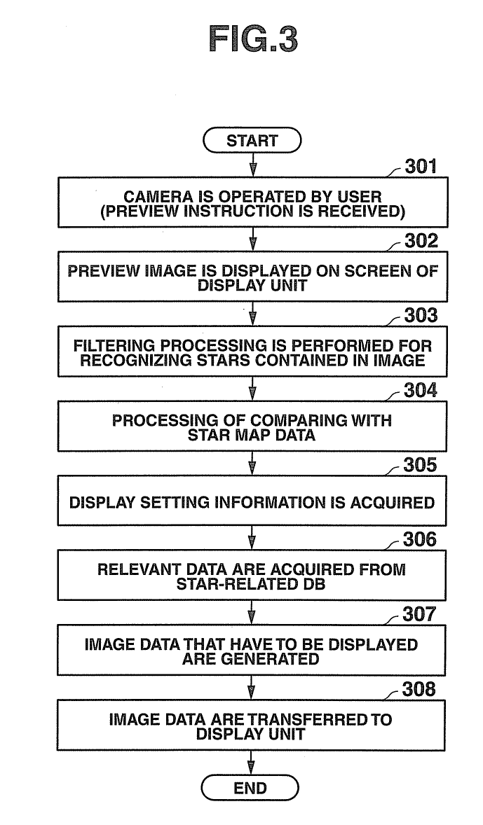

FIG. 3 is a flowchart illustrating an example of processing executed in the celestial body observation device of the present embodiment. In the present embodiment, the observer directs the lens of the camera 12 of the celestial body observation device in the desired direction and starts observations by operating the input unit 18 (for example, provides a preview instruction).

Where the preview instruction is received from the observer (step 301), the image processing unit 22 acquires image data from the camera unit 21 and outputs the acquired image data to the display control unit 34. As a result, image data picked up by the lens of the camera unit 21 are displayed as a preview image on the screen of the display unit 19 (step 302). The observer can display an image of the desired field angle on the screen of the display unit 19 by operating a zoom switch (not shown in the figure) of the input unit 18. In this case, the zoom control unit 23 controls the lens of the camera unit 21 correspondingly to the operation of the zoom switch performed by the observer.

For example, where the observer operates the switch of the input unit 18, the image processing unit 22 executes filtering processing of image data of the preview image (step 303). In the filtering processing, the image data are so processed that only pixels with a luminance equal to or higher than a predetermined luminance are left. As a result, only a series of pixel group corresponding to stars with a class equal to or higher than a predetermine class (for example, class 6) are present in the image data. Furthermore, adjacent pixel groups having a fixed luminance are recognized as stars, the recognized pixel groups are associated with the position and luminance thereof, and the association is stored in the RAM 14. As a result, the position and luminance of the pixel group recognized as a star in the image data are defined.

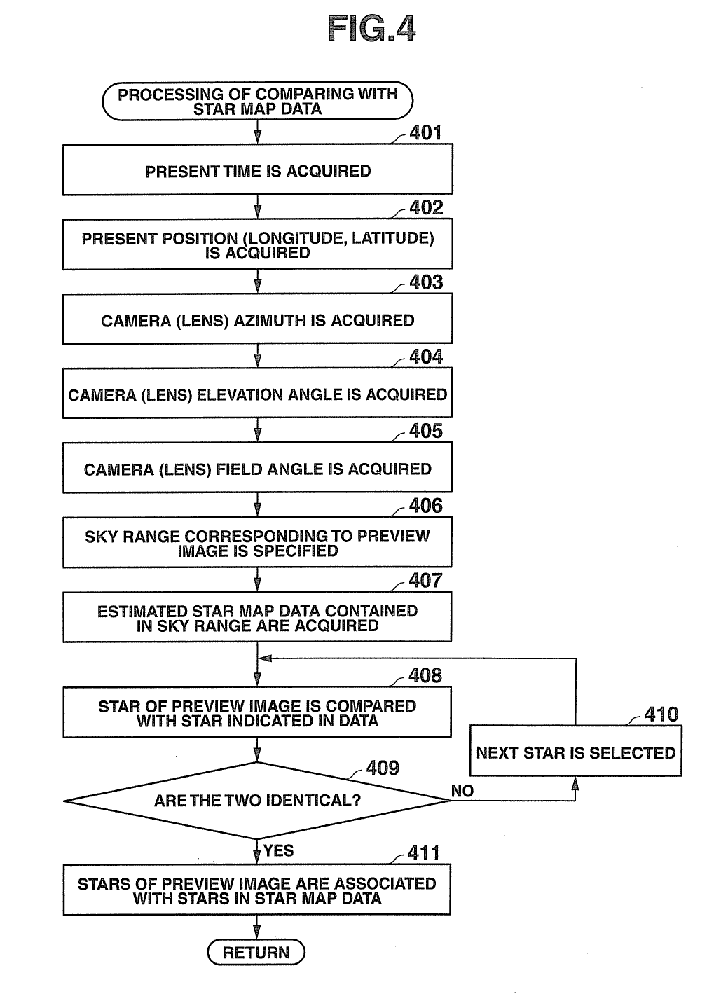

Then, the comparison and determination unit 31 executes a processing of comparing the pixel group recognized as the star with the star map data of the star map data file 35 of the star-related DB 33 (step 304). FIG. 4 is a flowchart illustrating an example of a processing of comparing with star map data relating to the present embodiment. As shown in FIG. 4, the comparison and determination unit 31 executes positioning with respect to the GPS device 17, acquires a present time (step 401), and also acquires the present position (longitude, latitude) (step 402). Actually the GPS device 17 receives GPS electromagnetic waves from two GPS satellites in a two-dimensional mode and from four GPS satellites in a three-dimensional mode and obtains the present time and the present position.

The comparison and determination unit 31 acquires the azimuth of the lens of the camera unit 21 on the basis of information from the azimuth sensor 29 (step 403) and also acquires the elevation angle of the lens on the basis of information from the elevation angle sensor 30 (step 404). Furthermore, the comparison and determination unit 31 acquires the field angle of the lens of the camera unit 21 from the field angle calculation unit 24 (step 405). A sky range corresponding to the preview image is specified by the azimuth (azimuth angle) of the lens, elevation angle of the lens, and field angle of the lens (step 406).

Then, the comparison and determination unit 31 acquires star map data relating to the stars contained in the specified sky range from the star map data file 35 (step 407). The comparison and determination unit 31 selects a certain pixel group from among the pixel groups corresponding to stars in the image data subjected to filtering processing and compares the selected pixel group with star map data relating to stars positioned in the specified sky range (step 408). In this comparison, for example, a luminance of the pixel group corresponding to a star is compared with a luminance of star map data of the star that is a comparison object, a position of a pixel group adjacent to the aforementioned pixel group is compared with a position of a star adjacent to the star that is a comparison object, and a luminance of the adjacent pixel group is compared with a luminance of the adjacent star. Where the luminance of the pixel group corresponding to the star is almost identical to the luminance of star map data relating to the star that is a comparison object (the difference is within a fixed range), the position of the pixel group adjacent to the aforementioned pixel group is almost identical to the position of the star adjacent to the star that is a comparison object (the difference is within a fixed range), and a luminance of the adjacent pixel group is almost identical to the luminance of the adjacent star (the difference is within a fixed range), the pixel group corresponding to a star can be determined to be identical to the star that is a comparison object. Furthermore, by expanding the range of adjacent pixel groups and studying the match of position and luminance with the star map data relating to other stars, it is possible to associate successively the respective pixel groups with stars.

The comparison of pixel groups with stars in step 408 is not limited to the above-described comparison. For example, a configuration may be employed in which matching is executed between the pixels constituting image data of the preview image and pixels constituting image data obtained by developing the star map data corresponding to the above-described range of sky, calculating a sum total of correlation values, for example, shifting the image data of the preview image, repeating the matching, specifying the matching operation with the largest sum total of correlation values, and obtaining the correspondence of pixel group and star of this operation.

The comparison and determination unit 31 determines whether correspondence was established between a pixel group in the preview image and a star (step 409). If the determination result of step 409 is No, star map data relating to the next star are selected in the star map data file 35 (step 410) and comparison is performed between the pixel group corresponding to the star in the preview image and the star map data of the selected star (step 408). If the determination result of step 409 is Yes, data including the association between each pixel group corresponding to a star in the preview image and the star map data are stored in the RAM 14 (step 411).

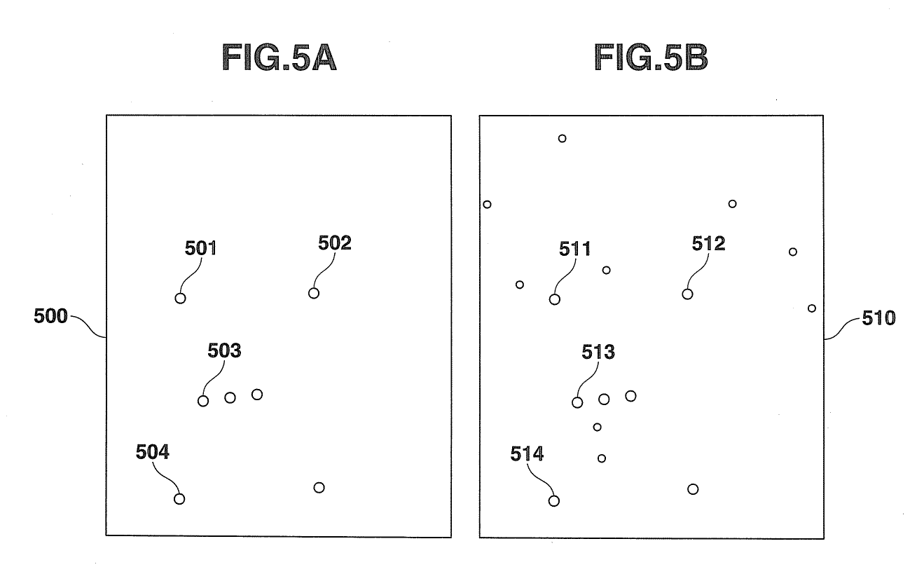

FIG. 5 illustrates an example of a preview image and star map data corresponding to specified sky. Actual data indicate the position or luminance of a pixel group (star), but in FIG. 5, the data are shown as a visualized state in the sky. As a result of processing shown in FIG. 4, a correspondence is established between a pixel group of a predetermined luminance in a preview image 500 and a star indicated by star map data 510. In FIG. 5A, for example, pixel groups 501-504 in the preview image 500 respectively correspond to stars 511-514 indicated by star map data in FIG. 5B. The star map data include necessary information such as star name and class. Further, information relating to a constellation to which the star belongs is included in the constellation data file 36. Therefore, the above-described comparison processing can specify the name of the star associated with the pixel group in the preview image or the name of the constellation to which this star belongs.

The relevant data extraction and processing unit 32 acquires display setting information inputted by the observer operating the input key of the input unit 18 (step 305). In the present embodiment, the display setting information includes, for example, such items as “a constellation line”, “a constellation name”, “a star name”, and “a galaxy—star cluster name”, and the observer can select one or more of these items by operating the input key. The display control unit 34 acquires the relevant data from the star-related DB 33 correspondingly to the items contained in the display setting information (step 306). Then, image data are generated in which the display based on the data acquired from the star-related DB 33 is superimposed on the preview image (step 307). The image data are transferred to the display unit 19 (step 308). As a result, an image having added thereto the display setting information selected by the observer is displayed on the screen of the display unit 19.

For example, when the display setting information includes “a constellation line” and “a constellation name”, the relevant data extraction and processing unit 32 specifies stars included in the preview image with reference to the star map data in the star map data file 35 and reads the name of the constellation to which each star belongs and data on the constellation lines that connect the stars from the constellation data file 36. The display control unit 34 then generates image data onto which displays of the constellation name and constellation lines are superimposed.

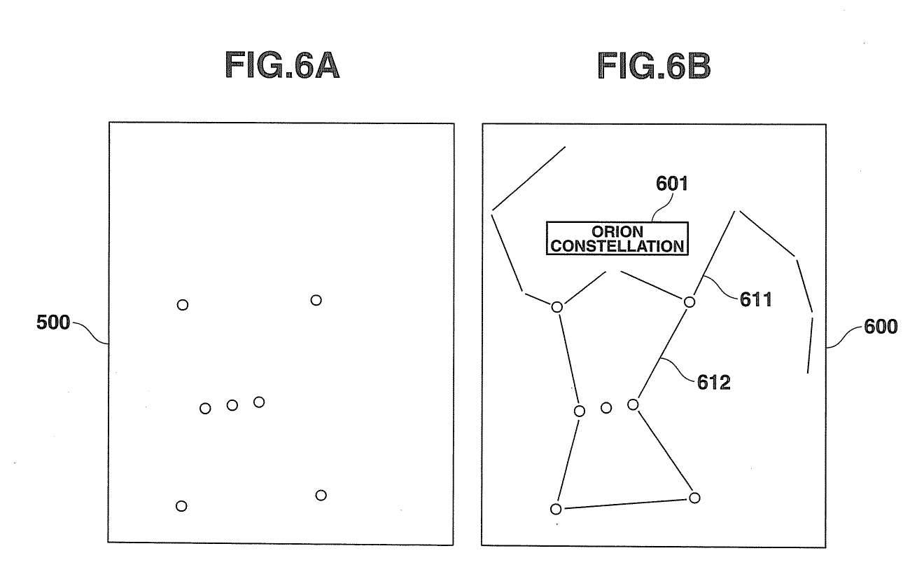

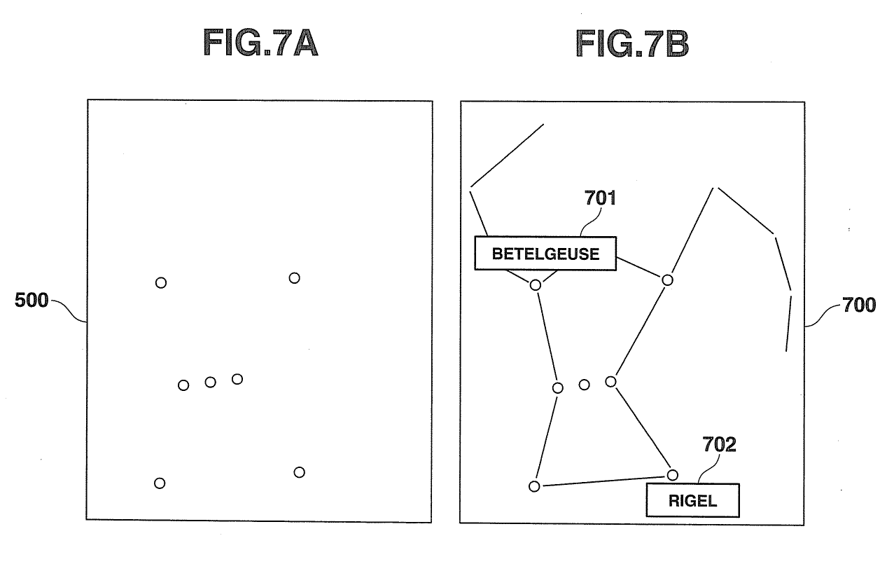

FIG. 6 illustrates an example of a preview image and an image in which a constellation name and constellation lines are superimposed on the preview image. A preview image 500 in FIG. 6A is identical to that shown in FIG. 5A. In an image 600 shown in FIG. 6B, a constellation name (see reference numeral 601) and constellation lines (for example, see reference numerals 611 and 612) are superimposed on the preview image. FIG. 7 illustrates another example of a preview image and an image in which a star name and constellation lines are superimposed on the preview image. A preview image 500 in FIG. 7A is identical to that shown in FIG. 5A. In an image 700 shown in FIG. 7B, star names (see reference numerals 701 and 702) and constellation lines are superimposed on the preview image.

Preview image data or image data having added thereto the display setting information selected by the observer are stored in the image memory 26 in response to the key operation of the input unit 18 by the observer.

When it is determined that a galaxy is contained in the preview image, that is, when the comparison processing determines that a pixel group in the preview image corresponds to a galaxy, an image is generated in which the display of the galaxy name acquired from the galaxy data file 37 is superimposed on the preview image, and the generated image is displayed on the screen of the display unit 19.

With the present embodiment, a celestial body is associated with a pixel group in image data on the basis of image data acquired by the camera, and display setting information of the celestial body associated with the pixel group, for example, the display of a star name is displayed in superposition on the image data. Therefore, information relating to stars that are presently seen can be acquired by referring to the image displayed on the screen of the display unit, without actually viewing the sky (it is not necessary to move a line of view).

Further, with the present embodiment, the image data pick-up date and hour can be measured. Therefore, it is possible to restrict the star map data from the star map data file to those of a star that can be picked up at the relevant pick-up date and hour and can be contained in the image data. In addition, with the present embodiment, the pick-up position of pick-up data is measured. Therefore, it is possible to restrict the star map data to those that can be picked up from the pick-up position and can be contained in the image data. As a result, a load on the comparison processing that associates a pixel group in the image data with a star can be reduced and the comparison processing can be implemented within a short interval.

Furthermore, with the present embodiment, the orientation and elevation angle of the lens of the camera unit are detected. As a result, a sky portion onto which the camera lens is directed can be specified and celestial body data serving as an object of comparison with the pixel group can be restricted to the celestial body data relating to the celestial body included in the aforementioned sky portion.

Furthermore, by calculating the field angle of the lens of the camera unit, it is possible to specify almost perfectly a sky portion contained in the image data. As a result, a load on the comparison processing that associates a pixel group in the image data with a star can be reduced and the comparison processing can be implemented within a short interval.

Furthermore, in the present embodiment, a constellation data file that stores constellation data having constellation names, celestial bodies constituting the constellations, and constellation lines connecting the celestial bodies is provided, and the display of the constellation names and constellation lines is superimposed on the image data. Therefore, the constellations, rather than only the star names, can be known without actually looking at the sky (in order words, without moving the line of view).

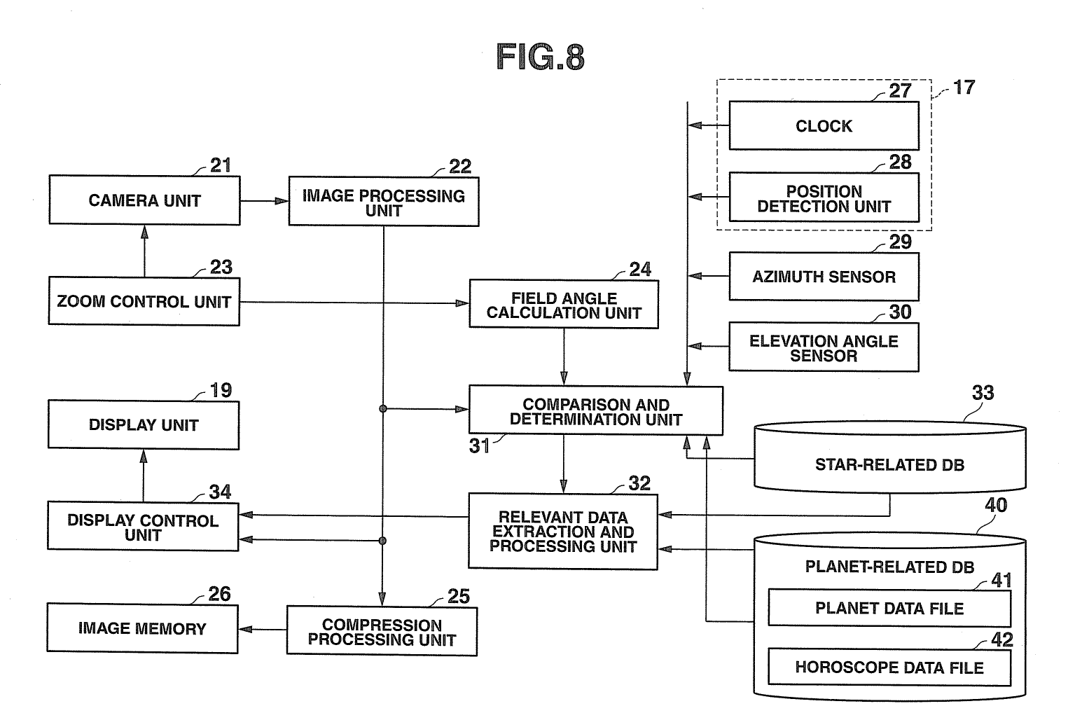

The second embodiment of the present invention will be described below. In the first embodiment, a star name or constellation is specified with reference to the star-related DB33 storing star map data file 35, constellation data file 36, and galaxy data file 37, and an image onto which the display indicating the star name and constellation is superimposed is provided to the observer. In the second embodiment, a planet-related database 40 storing various data relating to planets is additionally provided and an image having superimposed thereon information relating to planets can be provided to the observer. FIG. 8 is a block diagram illustrating functions of the celestial body observation device of the second embodiment. In FIG. 8, structural components identical to those of the celestial body observation device of the first embodiment shown in FIG. 2 are assigned with identical reference numerals. The celestial body observation device of the second embodiment comprises the planet-related database (DB) 40 in addition to the structural components of the celestial body observation device of the first embodiment.

The planet-related DB 40 includes a planet data file 41 including information on planets associated with a position in the sky and date-hour and a horoscope data file 42 including information on a horoscope associated with planets and date-time.

In the celestial body observation device of the second embodiment, processing is also executed according to flowchart shown in FIG. 3. Thus, where a preview instruction is received from the observer (step 301), the image processing unit 22 acquires image data from the camera unit 21 and outputs the acquired image data to the display control unit 34. As a result, image data picked up by the lens of the camera unit 21 are displayed as a preview image on the screen of the display unit 19 (step 302). The observer can display an image of the desired field angle on the screen of the display unit 19 by operating a zoom switch (not shown in the figure) of the input unit 18. In this case, the zoom control unit 23 controls the lens of the camera unit 21 correspondingly to the operation of the zoom switch performed by the observer. The image processing unit 22 executes filtering processing of image data of the preview image (step 303). The filtering processing verifies the position and brightness (luminance) of pixel groups recognized as stars in the image date. The comparison and determination unit 31 executes a processing of comparing the pixel group recognized as the star with the star map data within the star map data file 35 of the star-related DB 33 and planet data within the planet data file 41 of the planet-related DB 40 (step 304).

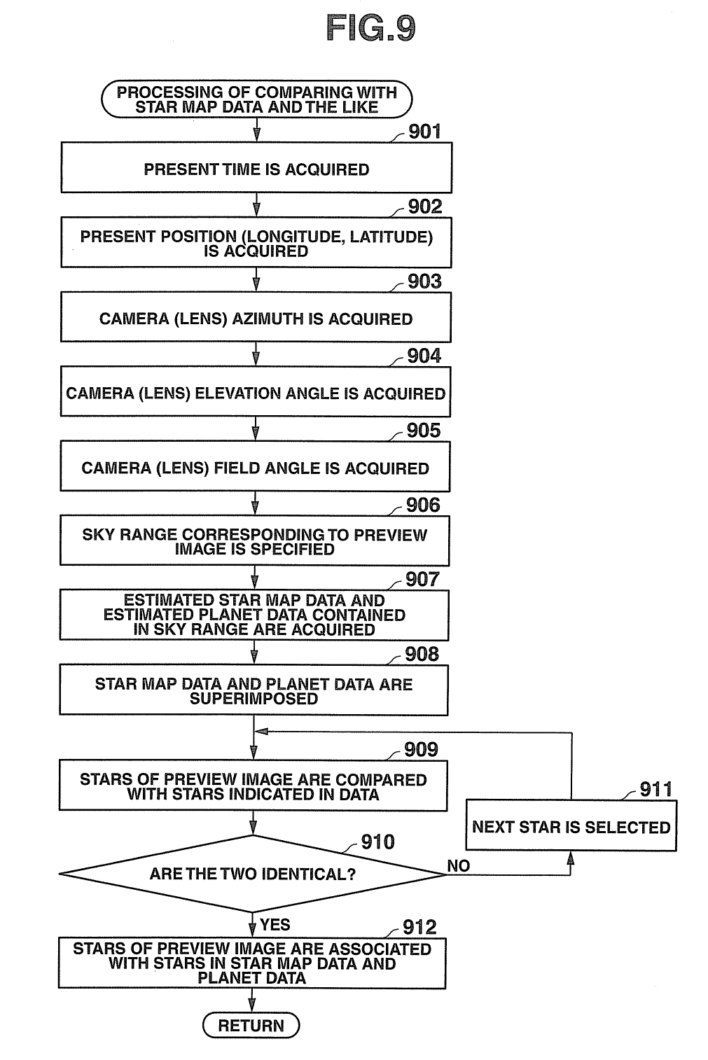

FIG. 9 is a flowchart illustrating an example of comparison processing with star map data and planet data in the second embodiment. Step 901 to step 906 in FIG. 9 are identical to steps 401-406 in FIG. 4. In other words, the comparison and determination unit 31 specifies a sky-range corresponding to the preview image by the present time, present position, and azimuth, elevation angle, and field angle of the lens of the camera 21 obtained in steps 901-905.

Then, the comparison and determination unit 31 acquires star map data corresponding to the specified sky range from the star map data file 35 and acquires planet data corresponding to the sky range from the planet data file 41 (step 907). The comparison and determination unit 31 generates composite data in which the star map data and planet data overlap (step 908). The composite data include positions and luminance of stars and positions and luminance of planets. Therefore, the comparison and determination unit 31 selects a certain pixel group from among pixel groups corresponding to stars in the image data subjected to filtering processing and compares the selected pixel group with the star map data or planet data indicated in the composite data corresponding to the specified sky range (step 909). The comparison in step 909 is identical to the comparison in step 408 of the first embodiment.

The comparison and determination unit 31 determines whether correspondence has been established between a pixel group in the preview image and a star or a planet in the composite data (step 910). If the determination result of step 910 is No, next star data or planet data are selected in the composite data (step 911), and comparison is performed between the pixel group corresponding to the star in the preview image and the star map data or planet data (step 909). If the determination result of step 910 is Yes, data including the association between each pixel group corresponding to a star in the preview image and the star map data or planet data are stored in the RAM 14 (step 912).

The relevant data extraction and processing unit 32 acquires display setting information inputted by the observer operating the input key of the input unit 18 (step 305). In the second embodiment, the display setting information includes, for example, such items as “a planet name”, “a horoscope ”, and “a distance to the planet” in addition to “a constellation line”, “a constellation name”, “a star name”, and “a galaxy—star cluster name”, and the observer can select one or more of these items by operating the input key of the input unit 18.

The display control unit 34 acquires the relevant data from the star-related DB 33 or planet-related DB 40 correspondingly to the items contained in the display setting information (step 306). Then, image data are generated in which the display based on the data acquired from the star-related DB 33 or planet-related DB 40 is superimposed on the preview image (step 307). The image data are transferred to the display unit 19 (step 308). As a result, an image having added thereto the display setting information selected by the observer is displayed on the screen of the display unit 19.

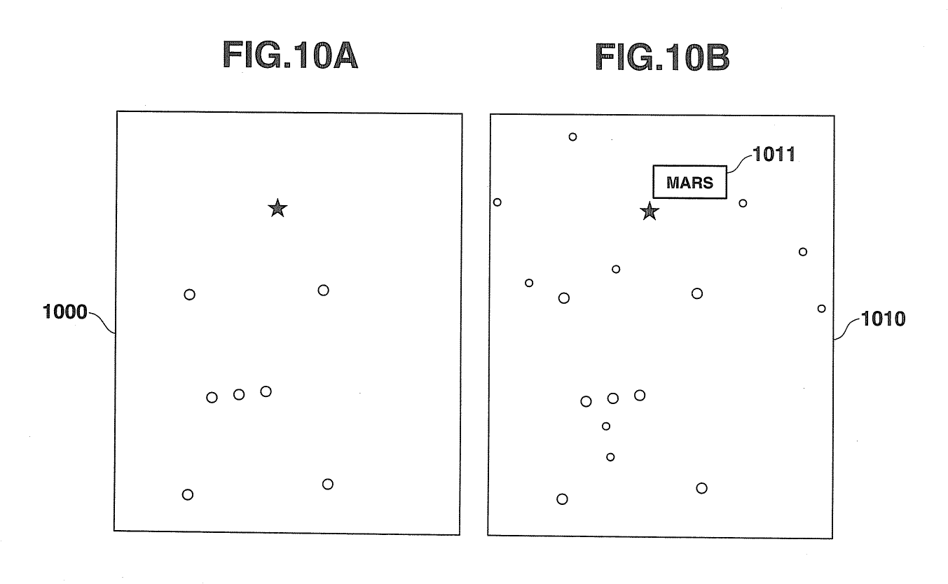

FIG. 10 illustrates an example of a preview image and an image in which a planet name is superimposed on the preview image. In the example shown in FIG. 10, “a planet name” is selected as the display setting information. Therefore, the relevant data extraction and processing unit 32 reads the name of the planet contained in the preview image with reference to the planet data in the planet data file 41, and the display control unit 34 generates image data onto which the planet name display is superimposed. In the preview image 1000 shown in FIG. 10A, only a pixel group corresponding to stars or planets is displayed, but in an image 1010 shown in FIG. 10B, the planet name (see reference numeral 1011) is superimposed on the preview image.

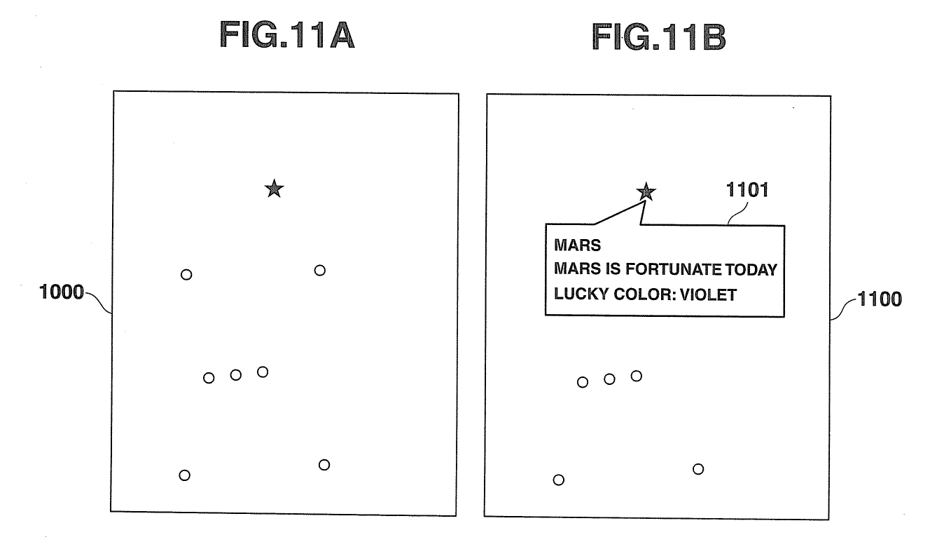

FIG. 11 illustrates another example of a preview image and an image in which a planet name and a horoscope display are superimposed on the preview image. The preview image in FIG. 11A is identical to that shown in FIG. 1A. In the example shown in FIG. 11, “a planet name” and “horoscope” are selected as display setting information. Therefore, the extraction and processing unit 32 reads the name of the planet included in the preview image with reference to the planet data contained in the planet data file 41 and also reads the horoscope data associated with the planet and the present time (date and hour) in the horoscope data file 42, and the display control unit 34 generates image data onto which the planet name and horoscope display is superimposed. In the image 1100 shown in FIG. 11b, the planet name and horoscope (see reference numeral 1101) are superimposed on the preview image.

In the second embodiment, the preview image data or image data having added thereto display setting information selected by the observer are also stored in the image memory 26 by the key operation of the input unit 18 performed by the observer.

When the display setting information is “a distance to the planet”, the relevant data extraction and processing unit 32 acquires the distance to the planet contained in the preview image with reference to the planet data contained in the planet data file 41, and the display control unit 34 generates image data onto which the display of the distance to the planet is superimposed.

With the second embodiment, pixel groups in the image are associated with planets on the basis of image data acquired by the camera, and information of various kinds (horoscope, distance to the planet, and the like) relating to the planet is displayed with superposition on the image data. Therefore, information relating to stars that are presently seen can be acquired by the observer by referring to the image displayed on the screen of the display unit, without actually viewing the sky (it is not necessary to move a line of view).

Furthermore, in the second embodiment, a planet data file that stores planet data having planet names, horoscope information relating to planets, and distance between the planets is provided, and the display of the planet names is superimposed on the image data. Therefore, the planet name and other information relating to the planet can be known without actually looking at the sky (in order words, without moving the line of view).

The present invention is not limited to the above-described embodiments, and various modifications can be made within the scope of the invention described in the claims. It goes without saying that these modifications are also included in the scope of the present invention.

What is claimed is:

1. A celestial body observation device comprising:
a camera;
a database comprising a celestial body data file that stores celestial body data having a position of a celestial body and display information including a name of the celestial body;
celestial body comparison and determination means for comparing a pixel group having a constant luminance contained in image data picked up by the camera with celestial body data within the celestial body data file and specifying a celestial body corresponding to the pixel group;
image data generation means for acquiring display information of celestial body data relating to the celestial body associated with the pixel group from the celestial body data file on the basis of association between the pixel group specified by the celestial body comparison and determination means and the celestial body and generating complex image data in which the display information is superimposed on the image data; and display means for displaying the complex image data.

2. The celestial body observation device according to claim 1, further comprising
time measuring means for measuring pickup date and hour of the image data, wherein
the celestial body comparison and determination means specifies a celestial body that can be picked up in the image data at the pick-up date and hour and takes celestial body data of the specified celestial body as an object of comparison with the pixel group.

3. The celestial body observation device according to claim 1, further comprising
positioning means for measuring a pick-up position of image data, wherein
the celestial body comparison and determination means specifies a celestial body that can be picked up in the image data in the pick-up position and takes celestial body data of the specified celestial body as an object of comparison with the pixel group.

4. The celestial body observation device according to claim 1, further comprising
detection means for detecting an azimuth and an elevation angle of a lens of the camera, wherein
the celestial body comparison and determination means specifies a portion of sky on the basis of the azimuth and elevation angle of the lens and takes celestial body data of the celestial body positioned in the portion of sky as an object of comparison with the pixel group.

5. The celestial body observation device according to claim 4, further comprising
field angle calculation means for calculating a field angle of a lens of the camera, wherein
the celestial body comparison and determination means specifies a portion of sky on the basis of the azimuth and elevation angle of the lens and also the field of angle of the lens and takes celestial body data of the celestial body positioned in the portion of sky as an object of comparison with the pixel group.

6. The celestial body observation device according to claim 1, wherein
the data base includes a constellation data file that stores constellation data including a constellation name, celestial bodies constituting the constellation, and constellation lines connecting the celestial bodies; and
the image data generation means acquires constellation data of a constellation including celestial bodies associated with the pixel groups from the constellation data file on the basis of association of the pixel groups with the celestial bodies and generates composite image data in which at least one from among the constellation name, and constellation lines connecting the celestial bodies corresponding to the pixel groups is superimposed on the image data.

7. The celestial body observation device according to claim 1, wherein
the data base includes a planet data file that stores planet data including a name of a planet from among the celestial bodies and horoscope information relating to the planet; and
the image data generation means acquires planet data of planets associated with the pixel groups on the basis of association of the pixel groups with the celestial bodies and generates composite image data in which at least one from among the planet names and horoscope information relating to the planet is superimposed on the image data.
